(19) United States
(12) Patent Application Publication
(10) Pub. No.: US 2009/0296883 A1
(43) Pub. Date: Dec. 3, 2009

(54) Radiation image correction apparatus, method, and program

(75) Inventor: Takaaki Saito, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/453,971

(22) Filed: May 28, 2009

(30) Foreign Application Priority Data
May 29, 2008 (JP) JP 140960/2008

(51) Int. Cl. G01N 23/04; G06K 9/00

(52) U.S. Cl. 378/62; 382/132

(57) ABSTRACT

A radiation image correction apparatus which includes a data acquisition unit for acquiring, from each of two target radiation images for comparative reading obtained for the same subject, data of approximate density unevenness using pixel values of a predetermined region of each of the radiation images, and a correction unit for correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.

### BACKGROUND OF THE INVENTION

1. Field of the Invention

The present invention relates to a radiation image correction apparatus and method for correcting a pixel value of either one of two target radiation images for comparative reading obtained from the same subject. The invention also relates to a computer readable recording medium on which is recorded a program for causing a computer to perform the radiation image correction method.

2. Description of the Related Art

In the medical field, a comparative reading of two or more images of a certain patient taken at different times is performed to detect an abnormal tissue pattern based on the difference between the images or to consider the treatment plan for the patient based on the progressive or recovery state of the disease.

The two target images for comparative reading obtained in a time series manner, however, may often differ in image characteristics, such as gradation, frequency characteristic, resolution, density, luminance, and the like. Therefore, when performing comparative reading, processing for matching the image characteristics is generally performed. As one of the methods for matching the image characteristics, a method in which gradation processing, frequency processing, pixel size correction processing, dynamic range compression processing, position alignment processing, and the like are performed on at least either one of two target images of the same subject for comparative reading is proposed as described, for example, in U.S. Pat. No. 6,744,849.

Recently, there has been a growing need in medical practices for photographing patients having difficulties to move from their hospital bedrooms, or emergency photographing in an operation room, and mobile X-ray apparatus (hereinafter, visiting car) for visiting a bedroom or the like and performing X-ray photography is being put into practical use. In particular, for the purpose of respiratory and circulatory management of critically ill hospitalized patients, it is practiced to periodically take chest X-ray images of a subject (patient) lying on the bed by the visiting car and to monitor the progress of the illness over time by performing comparative readings of a plurality of chest images taken at different times.

When performing photography by the visiting car, a cassette is placed behind a subject lying on the bed, so that unreproducible density unevenness may sometimes occur in radiation images due to the position and orientation of the cassette with respect to the radiation source, posture of the patient, and the like that irregularly vary every time the photography is performed. In particular, the presence of such unreproducible density unevenness in each of two target radiation images for comparison degrades the performance of the comparative reading. Further, in the method described in U.S. Pat. No. 6,744,849, the influence of such unreproducible density unevenness to the performance of comparative reading and countermeasures to be taken against it are not discussed.

In view of the circumstances described above, it is an object of the present invention to provide a radiation image correction apparatus and method that allows an appropriate comparative reading even when unreproducible density unevenness is present in target radiation images for comparative reading. It is a further object of the present invention to provide a computer readable recording medium on which is recorded a program for causing a computer to perform the radiation image correction method.

### SUMMARY OF THE INVENTION

A radiation image correction apparatus of the present invention is an apparatus, including:

a data acquisition unit for acquiring, from each of two target radiation images for comparative reading obtained for the same subject, data of approximate density unevenness using pixel values of a predetermined region of each of the radiation images; and

a correction unit for correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.

In the apparatus described above, the two radiation images may be frontal chest radiation images of a human body, and the data acquisition unit may be a unit that obtains a region in which ribs are imaged in overlapping fashion located in each of left and right outer contour portions of the rib cage in each of the frontal chest radiation images as the predetermined region and acquires the data using pixel values of the obtained region.

Further, the data acquisition unit may be a unit that obtains a direct exposure region exposed directly to radiation as the predetermined region and acquires the data using pixel values of the obtained region.

Still further, the two radiation images may be frontal chest radiation images of a human body, the apparatus may further include a selection information receiving unit for receiving information indicating which of a region in which ribs are imaged in overlapping fashion located in each of left and right outer contour portions of the rib cage and a direct exposure region exposed directly to radiation in each of the frontal chest radiation images is to be obtained as the predetermined region, and the data acquisition unit may be a unit that obtains either one of the regions based on the information received by the selection information receiving unit and acquires the data using pixel values of the obtained region.

Further, the apparatus may further include a specifying information receiving unit for receiving information specifying the predetermined region, and the data acquisition unit may be a unit that obtains the predetermined region based on the information received by the specifying information receiving unit and acquires the data using pixel values of the obtained region.

A radiation image correction method is a method, including the steps of:

acquiring, from each of two target radiation images for comparative reading obtained for the same subject, data of approximate density unevenness using pixel values of a predetermined region of each of the radiation images; and

correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.

A computer readable recording medium of the present invention is a medium on which is recorded a program for causing a computer to perform the method described above.

In the radiation image correction method, apparatus, and program, it is only necessary that correction is performed on pixel values of either one of the two radiation images such that data of approximate density unevenness to be obtained from each of the radiation images after the correction will correspond to each other, and it is not necessary to actually obtain the data of approximate density unevenness from each of the radiation images after the correction.

Further, both of the two images are not necessarily corrected, and when either one of the images is corrected, the term “each of the radiation images after the correction” refers to two images one of which is corrected while the other of which is not.

According to the radiation image correction method, apparatus and program of the present invention, from each of two target radiation images for comparative reading obtained for the same subject, data of approximate density unevenness are acquired using pixel values of a predetermined region of each of the radiation images, and pixel values of at least one of the two radiation images are corrected based on the data of approximate density unevenness acquired from each of the radiation images such that data of approximate density unevenness to be obtained from each of the radiation images by the data acquisition unit after the correction will correspond to each other. This allows density unevenness present in each of the two target radiation images for comparative reading, so that the difference between the images becomes easy to visually recognize, whereby the performance of comparative reading may be improved.

In the method, apparatus, and program described above, either one of a region in which ribs are imaged in overlapping fashion located in each of left and right outer contour portions of the rib cage and a direct exposure region exposed directly to radiation may be obtained as the predetermined region. When density unevenness is not present in a radiation image, the region in which ribs are imaged in overlapping fashion located in each of left and right outer contour portions of the rib cage has a density distribution which is at least symmetrical with respect to the body axis of the subject, and the direct exposure region has a substantially uniform density distribution, so that the density unevenness of the radiation image may be obtained by checking pixel values of either one of the regions.

### BRIEF DESCRIPTION OF THE DRAWINGS

FIG. 1 is a schematic configuration diagram of a radiation image correction apparatus according to an embodiment of the present invention.

FIG. 2 is a drawing for explaining radiation image correction processing performed by the radiation image correction apparatus shown in FIG. 1.

FIG. 3 illustrates an example body axis of a subject extracted from a target image.

FIG. 4 illustrates an example body axis of a subject extracted from a reference image.

FIG. 5 illustrates an example angle between the body axes of the subject extracted from the target image and reference image.

FIG. 6 illustrates an example direct exposure region in a radiation image.

### DESCRIPTION OF THE PREFERRED EMBODIMENTS

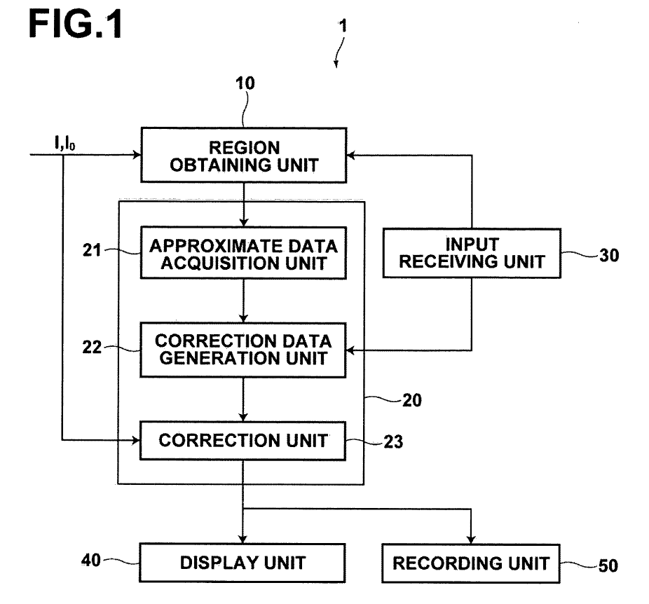

Hereinafter, an exemplary embodiment of a radiation image correction apparatus of the present invention will be described with reference to the accompanying drawings. Radiation image correction apparatus 1 according to an embodiment of the present invention shown in FIG. 1 is realized by executing a radiation image correction program, read in an auxiliary storage device, on a computer (e.g., personal computer, or the like). Here, the radiation image correction program is stored in information recording medium, such as CD-ROM or the like, or distributed through a network, such as the Internet, and installed on the computer.

Radiation image correction apparatus 1 is an apparatus that corrects pixel values of either one of two target images (hereinafter, “target image I(x,y)”) for comparative reading obtained for the same subject such that the density trend of the target image I(x,y) matches with that of the other image (hereinafter, “reference image Io(x,y)”). As shown in FIG. 1, radiation image correction apparatus 1 includes region obtaining unit 10, correction unit 20, input receiving unit 30, display unit 40, recording unit 50, and the like.

Here, the density unevenness in a radiation image due to the position or orientation of a cassette with respect to the radiation source and the posture of the patient that irregularly vary every time photography is performed is collectively referred to as the density trend.

Region obtaining unit 10 is a unit that obtains a region from each of target image I(x,y) and reference image Io(x,y) for extracting the density trend of each image.

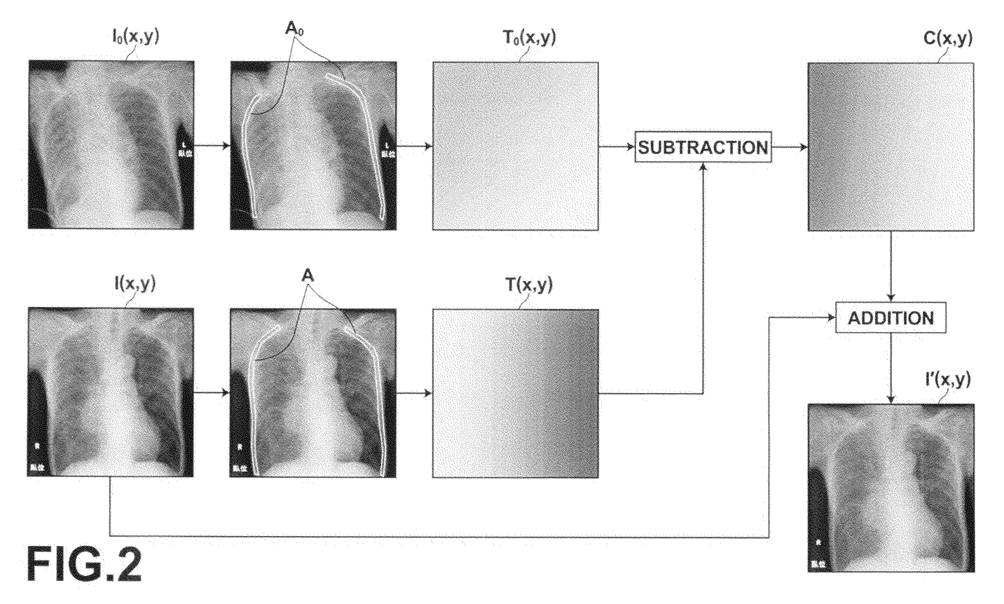

For example, when images I(x,y) and Io(x,y) are chest radiation images, region obtaining unit 10 obtains, for example, regions A and Ao (indicated by solid white outlines in FIG. 2) in which ribs are imaged in overlapping fashion located in each of left and right outer contour portions of the rib cage as the region for extracting the density trend of the images, as shown in FIG. 2. The region in which ribs are imaged in overlapping fashion located in each of left and right outer contour portions of the rib cage is a region outside of the lung fields which are generally the target region for observing pathological changes, i.e., the region not influenced by the pathological condition, and has a density distribution which is at least symmetrical with respect to the body axis of the subject when density unevenness is not present. Therefore, the density trend in the image may be obtained by checking the pixel values of the region.

More specifically, region obtaining unit 10 determines a region enclosed by the outer contour, inner contour, and lower contour of the right lung, and outer contour, inner contour, and lower contour of the left lung using, for example, the technique described in Japanese Unexamined Patent Publication No. 2003-006661 with respect to each of image I(x,y) and image Io(x,y), and obtains the region in which ribs are imaged in overlapping fashion located in each of left and right outer contour portions of the rib cage by extracting a region from each of the left and right contours of the determined region to outside with a width approximately corresponding to the width such regions generally have.

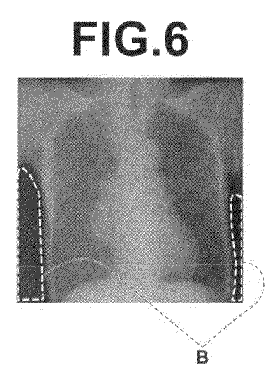

Further, when, for example, a direct exposure region directly exposed to radiation is present in target image I(x,y) and reference image Io(x,y) which extends to a degree that allows to obtain data of approximate density trend of each of the radiation images, as shown in FIG. 6, and if the area of continuously extending direct exposure region or the area of a geometry enclosing the entirety of a plurality of discretely extending direct exposure regions is sufficiently large, the direct exposure region (region B enclosed by white dashed lines in FIG. 6) may be obtained as the region for extracting the density trend of the images. The direct exposure region has a substantially uniform density distribution when density unevenness is not present. Therefore, the density trend in the image caused, in particular, by the position and orientation of the cassette with respect to the radiation source may be obtained by checking the pixel values of the region.

When image I(x,y) and image Io(x,y) are frontal chest radiation images, a determination as to which of the region in which ribs are imaged in overlapping fashion located in each of left and right outer contour portions of the rib cage and the direct exposure region directly exposed to radiation is to be obtained as the region for extracting the density trend of each of images I(x,y) and Io(x,y) may be made by, for example, having the user to input selection information to input receiving unit 30 as to which of the regions is to be obtained. Then, based on the inputted information, either one of the regions may be obtained.

Region obtaining unit 10 may be a unit that automatically detects and obtains the region in which ribs are imaged in overlapping fashion located in each of left and right outer contour portions of the rib cage or the direct exposure region directly exposed to radiation, or otherwise it may be a unit that obtains either one of the regions based on the information identifying which of the regions is to be obtained inputted to input receiving unit 30 by the user. As for the information specifying the region to be obtained broadly refers to information capable of specifying the range of the region, and includes, for example, position information of certain number of points specified so as to enclose the region desired by the user to specify on a radiation image, position information of each pixel in the region specified as the desired region by the user by filling the region, or the like.

Correction unit 20 includes approximate data acquisition unit 21 that acquires data of approximate density trend from each of images I(x,y) and Io(x,y) using pixel values of the region of each image obtained by region obtaining unit 10, correction data generation unit 22 that generates correction data for correcting target image I(x,y) using the obtained approximate data, and correction unit 23 that corrects pixel values of the radiation image using the generated correction data.

Approximate data acquisition unit 21 acquires, for example, data T and To of approximate density trends of target image I(x,y) and reference image Io(x,y) using pixel values of regions A and Ao obtained by region obtaining unit 10.

More specifically, with respect to target image I(x,y), approximate data acquisition unit 21 generates linear model Z(x,y) by approximating image signals of region A as shown in Formula (1) below. Here, the constants “a”, “b”, and “c” are parameters selected by, for example, least squares method so that most probable linear model Z(x,y) is obtained. More specifically, parameters that cause the square sum of the difference between pixel value A(x,y) of each pixel in region A and Z(x, y) to become the smallest value are searched for and obtained.

Z(x,y)=ax+by+c (1)

Then, using the obtained parameters “a” and “b”, and center coordinates (xc,yc) of target image I(x,y), approximate data acquisition unit 21 acquires the density trend in horizontal direction “x” and vertical direction “y” of target image I(x,y) approximated to the linear model as approximate data T(x,y), as shown in Formula (2) below.

T(x,y)=a(x−xc)+b(y−yc) (2)

Further, with respect to reference image Io(x,y), approximate data acquisition unit 21 acquires the density trend of reference image Io(x,y) approximated to the linear model as approximate data To(x,y)=ao(x−xc)+bo(y−yc) in the same manner as in target image I(x,y) using pixel values in region Ao. An example of each of data T(x,y) and To(x,y) obtained by approximating the density trends of target image I(x,y) and reference image Io(x,y) is shown in FIG. 2.

Correction data generation unit 22 is a unit that generates correction data C(x,y) for correcting target image I(x,y) using approximate data T(x,y) and To(x,y) obtained by approximate data acquisition unit 21. Correction data generation unit 22 generates the correction data C(x,y) by, for example, subtracting data T(x,y) obtained by approximating the density trend of target image I(x,y) from data To(x,y) obtained by approximating the density trend of reference image Io(x,y) shown in FIG. 2, C(x,y)=To(x,y)−T(x,y).

When the region for extracting the density trend of each of images I(x,y) and Io(x,y) is the region in which ribs are imaged in overlapping fashion located in each of left and right outer contour portions of the rib cage and the body axis of the subject in each of images I(x,y) and Io(x,y) is significantly different, it is preferable to obtain corrected data To′(x,y) corrected according to difference Φ before performing the subtraction described above, and then to perform the subtraction using data To′(x,y) in place of data To(x,y).

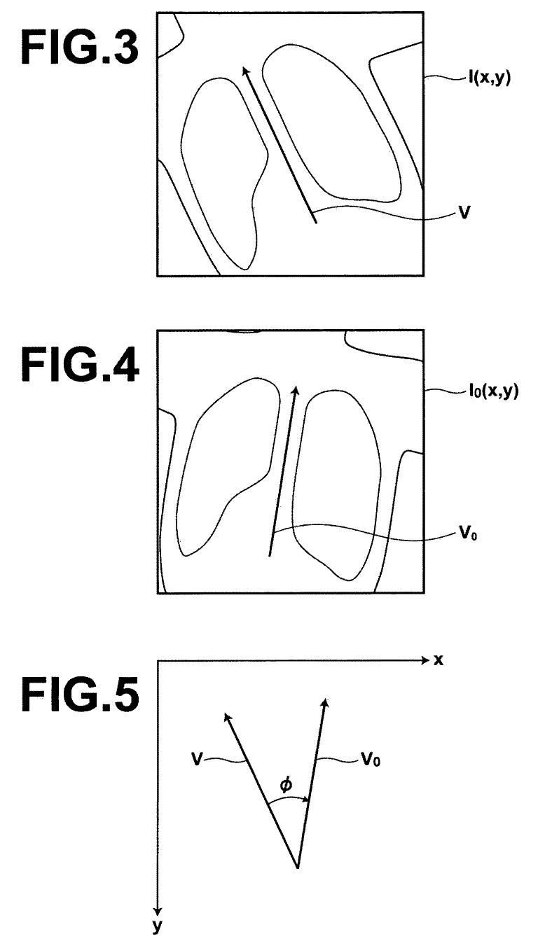

Hereinafter, processing for acquiring corrected data To′(x,y) will be described with reference to FIGS. 3 to 5. First, as illustrated in FIGS. 3 and 4, correction data generation unit 22 extracts body axes V and Vo of the subject from target image I(x,y) and reference image Io(x,y). More specifically, for example, as described in Japanese Patent Application No. 2008-037145, correction data generation unit 22 extracts an edge component value that includes an edge direction value corresponding to the width of the vertebral body and an edge intensity value corresponding to the width of the vertebral body at each pixel of the chest image using a Gabor filter. Then, correction data generation unit 22 estimates a direction obtained by averaging edge direction values, each corresponding to a highest edge intensity value at each pixel, weighted by the highest edge intensity value at each pixel in a region of interest that does not include left and right side end portions of the chest image which are the regions in which at least the clavicles overlap with ribs as the vertebral body direction. Next, correction data generation unit 22 scans the chest image in a direction substantially orthogonal to the estimated vertebral body direction to extract each pixel having a pixel value not greater than a predetermined value as a vertebral body region, and detects the middle line of the extracted vertebral body regions as the body axis of the subject.

Then, as illustrated in FIG. 5, correction data generation unit 22 obtains angle Φ between body axes V and Vo extracted from images I(x,y) and Io(x,y) respectively, and calculates the values of parameters “ao′” and “bo′” from the values of parameters “ao” and “bo” in data To(x,y)=ao(x−xc)+bo(y−yc) by Formula (3) below, thereby acquiring corrected data To′(x,y)=ao′(x−xc)+bo′(y−yc).

$$( \begin{matrix}{ao}^{′} \\ {bo}^{′}\end{matrix} ) = ( \begin{matrix}cos φ & sin φ \\ - sin φ & cos φ\end{matrix} ) ( \begin{matrix}ao \\ bo\end{matrix} ) \qquad ( 3 )$$

Parameters A and B in correction data C(x,y)=A(x−xc)+B(y−yc) generated in the manner as described above are outputted to correction unit 22. Note that it is also possible to display parameters A and B so generated on the screen of display unit 40, then accept modified values provided by the user from input receiving unit 30, modify parameters A and B using the inputted modified values, and output modified correction data to correction unit 22.

Correction unit 23 is a unit that corrects pixel values of target image I(x,y) using the correction data generated by correction data generation unit 22. As illustrated in FIG. 2, correction unit 23 generates corrected image I′(x,y) in which pixel values of target image I(x,y) are corrected so that the density trend of the corrected target image I(x,y) corresponds to the density trend of reference image Io(x,y) by adding correction data C(x,y) generated by correction data generation unit 22 to target image I(x,y).

Corrected image I′(x,y) generated in the manner as described above is displayed on the screen of display unit 40. Here, it is possible to indicate what correction was made to the user in an easily understandable way by displaying information, such as the parameters in correction data C(x,y) used for the correction performed by correction unit 23 and the like, on the screen with corrected image I′(x,y).

If the user inputs modified values through input receiving unit 30 for the parameters displayed on the screen with corrected image I′(x,y), correction data generation unit 22 accepts the modified values provided by the user from input receiving unit 30, modifies the parameters using the inputted modified values, and outputs the modified correction data to correction unit 23. Then, correction unit 23 corrects target image I(x,y) again using the inputted modified correction data, whereby density unevenness corrected image I′(x,y) may be generated.

Recording unit 50 is a unit that records corrected image I′(x,y) generated in the manner as described above and correction data C(x,y) used for the correction on a recording medium by associating them with each other.

In the configuration described above, a comparative reading using two radiation images (target image I(x,y) and reference image Io(x,y)) obtained for the same subject is performed in the following manner. First, with respect to each of target image I(x,y) and reference image Io(x,y), region obtaining unit 10 obtains the region in which ribs are imaged in overlapping fashion located in each of left and right outer contour portions of the rib cage or direct exposure region as the region for extracting the density trend of each image. Then, approximate data acquisition unit 21 acquires data T(x,y) and To(x,y) of approximate density trends of target image I(x,y) and reference image Io(x,y) using pixel values of each of the obtained regions. Next, correction data generation unit 23 generates correction data C(x,y) by subtracting data T(x,y) from data To(x,y). Then, correction unit 23 generates corrected image I′(x,y) by correcting pixel values of radiation image I(x,y) using correction data C(x,y) generated by correction data generation unit 22. Thereafter, display unit 40 displays corrected image I′(x,y) generated by correction unit 23, correction data C(x,y) used for the correction, and the like on the screen.

If the user inputs, through input receiving unit 30, modified values for the parameters of correction data C(x,y) displayed on the screen, correction data generation unit 22 accepts the modified values provided by the user from input receiving unit 30, modifies the parameters using the inputted modified values, and outputs the modified correction data to correction unit 23. Then, correction unit 23 corrects radiation image I(x,y) again using a function defined by the modified parameters, thereby generating corrected image I′(x,y). Thereafter, recording unit 50 records finally generated corrected image I′(x,y) and correction data used for the correction on a recording medium by associating them with each other.

The description has been made of a case in which corrected image I′(x,y) is generated by performing correction by directly using correction data C(x,y) generated by correction data generation unit 22, then the correction result is presented to the user to modify the correction data as required, and correction is performed again using the modified correction data. But, an arrangement may be adopted in which correction data C(x,y) generated by correction data generation unit 22 are displayed on the screen of display unit 40 before performing the initial correction to accept modification of the correction data by the user, and the correction is performed using the modified correction data.

According to the embodiment described above, pixel values of either one of two target radiation images for comparative reading obtained for the same subject are corrected to match the density unevenness present in the radiation images, so that the difference between the images becomes easy to visually recognize, whereby the performance of comparative reading may be improved.

Selection/determination as to which of two target images for comparative reading is to be used as the reference image for performing the correction according to the present invention may be made arbitrarily. But, it is preferable to select the image of relatively well positioned subject with less density unevenness as the reference image.

What is claimed is:

1. A radiation image correction apparatus, comprising:
a data acquisition unit for acquiring, from each of two target radiation images for comparative reading obtained for the same subject, data of approximate density unevenness using pixel values of a predetermined region of each of the radiation images; and
a correction unit for correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.

2. The radiation image correction apparatus of claim 1, wherein:
the two radiation images are frontal chest radiation images of a human body; and
the data acquisition unit is a unit that obtains a region in which ribs are imaged in overlapping fashion located in each of left and right outer contour portions of the rib cage in each of the frontal chest radiation images as the predetermined region and acquires the data using pixel values of the obtained region.

3. The radiation image correction apparatus of claim 1, wherein the data acquisition unit is a unit that obtains a direct exposure region exposed directly to radiation as the predetermined region and acquires the data using pixel values of the obtained region.

4. The radiation image correction apparatus of claim 1, wherein:
the two radiation images are frontal chest radiation images of a human body;
the apparatus further comprises a selection information receiving unit for receiving information indicating which of a region in which ribs are imaged in overlapping fashion located in each of left and right outer contour portions of the rib cage and a direct exposure region exposed directly to radiation in each of the frontal chest radiation images is to be obtained as the predetermined region; and
the data acquisition unit is a unit that obtains either one of the regions based on the information received by the selection information receiving unit and acquires the data using pixel values of the obtained region.

5. The radiation image correction apparatus of claim 2, wherein:
the apparatus further comprises a specifying information receiving unit for receiving information specifying the predetermined region; and
the data acquisition unit is a unit that obtains the predetermined region based on the information received by the specifying information receiving unit and acquires the data using pixel values of the obtained region.

6. The radiation image correction apparatus of claim 3, wherein:
the apparatus further comprises a specifying information receiving unit for receiving information specifying the predetermined region; and
the data acquisition unit is a unit that obtains the predetermined region based on the information received by the specifying information receiving unit and acquires the data using pixel values of the obtained region.

7. A radiation image correction method, comprising the steps of:
acquiring, from each of two target radiation images for comparative reading obtained for the same subject, data of approximate density unevenness using pixel values of a predetermined region of each of the radiation images; and
correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.

8. A computer readable recording medium on which is recorded a program for causing a computer to perform the steps of:
acquiring, from each of two target radiation images for comparative reading obtained for the same subject, data of approximate density unevenness using pixel values of a predetermined region of each of the radiation images; and
correcting pixel values of at least one of the two radiation images based on the data of approximate density unevenness acquired from each of the radiation images by the data acquisition unit such that data of approximate density unevenness to be obtained from each of the radiation images by the data acquisition unit after the correction will correspond to each other.
